(19) United States
(12) Patent Application Publication
(10) Pub. No.: US 2007/0236482 A1
(43) Pub. Date: Oct. 11, 2007

(54) Attachable display system for a portable device

(75) Inventors: David Walter Proctor, Bellevue, WA (US); Thamer Abanami, Seattle, WA (US); Brett Allen Bentsen, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/400,564

(22) Filed: Apr. 7, 2006

(51) Int. Cl. G09G 5/00

(52) U.S. Cl. 345/204

(57) ABSTRACT

A larger display can be directly attached to the portable device to enhance the experience of the portable device. In the case of video or pictures, the optimal resolution shows on the attachable display. When the attachable display is not connected, the local display on the device shows the appropriate resolution for the local display. The attachable display has a processor for decoding video from the device.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2006, Microsoft Corp.

### BACKGROUND

Many portable devices like MP3 players and mobile phones are increasing their feature set to include secondary features like video and pictures. Portable devices must be small enough for consumers to carry on their person frequently. Bill of material costs are crucial for the success of MP3 players and mobile phones, which results in using the cheapest possible processors and displays that meet the minimum bar of functionality. This means that some portable devices can only do limited functions where they can play music but not video. Due to the increased storage capacity of many of these devices, they may have the ability to store large files like digital video files, even if they cannot play them back. Even in the case of portable devices that can play video, the displays are usually small and uncomfortable to view for more than a few minutes.

Thus, needed are processes and a system that addresses the shortcomings of the prior art.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In consideration of the above-identified shortcomings of the art, an attachable display system for a portable device is provided. For several embodiments, an attachable display system for a portable device comprises an attachable display, operable for connection with no external wires to a portable device to display video stored on the portable device on the attachable display. The display may be removed by unplugging the display from the device.

A method for processing video data for possible display on an attachable display comprises downloading to a portable computing device video data of a resolution appropriate for the device's local display and downloading video data of at least one resolution appropriate for display on at least one attachable display for the portable device. Also, a check is made whether the device has a capability to display video of the appropriate resolution to an attachable device before downloading the video of the appropriate resolution to the device.

Other advantages and features of the invention are described below.

### BRIEF DESCRIPTION OF THE DRAWINGS

An attachable display system for a portable device is further described with reference to the accompanying drawings in which:

FIG. 1 is a block diagram representing an exemplary computing device suitable for use with an attachable display system for a portable computing device or suitable as the portable computing device;

FIG. 2 illustrates an exemplary networked computing environment in which many computerized processes may be implemented to perform communications with the attachable display system for a portable computing device or with the portable computing device;

FIG. 3 is a diagram illustrating a front view of an exemplary disconnected attachable display and exemplary portable computing device.

FIG. 4 is a diagram illustrating a front view of an exemplary connected attachable display and exemplary portable computing device;

FIG. 5 is a diagram illustrating a side view an exemplary connected attachable display and exemplary portable computing device;

FIG. 6 is a diagram illustrating a front view an exemplary connected attachable display with additional options and exemplary portable computing device displaying an optional menu;

FIG. 7 is a diagram illustrating a front view of an exemplary disconnected attachable display and exemplary portable computing device in wireless communication with each other;

FIG. 8 is a diagram illustrating a front view of a plurality of exemplary attachable displays connected to an exemplary portable computing device;

FIG. 9 is a flow chart illustrating an exemplary process of a portable computing device obtaining video data for possible display on an attachable display;

FIG. 10 is a diagram illustrating a front view of an exemplary portable computing device in communication with another computing device; and

FIG. 11 is a flow chart illustrating an exemplary process for a portable computing device displaying video data on an attachable display.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

Example Computing Environments

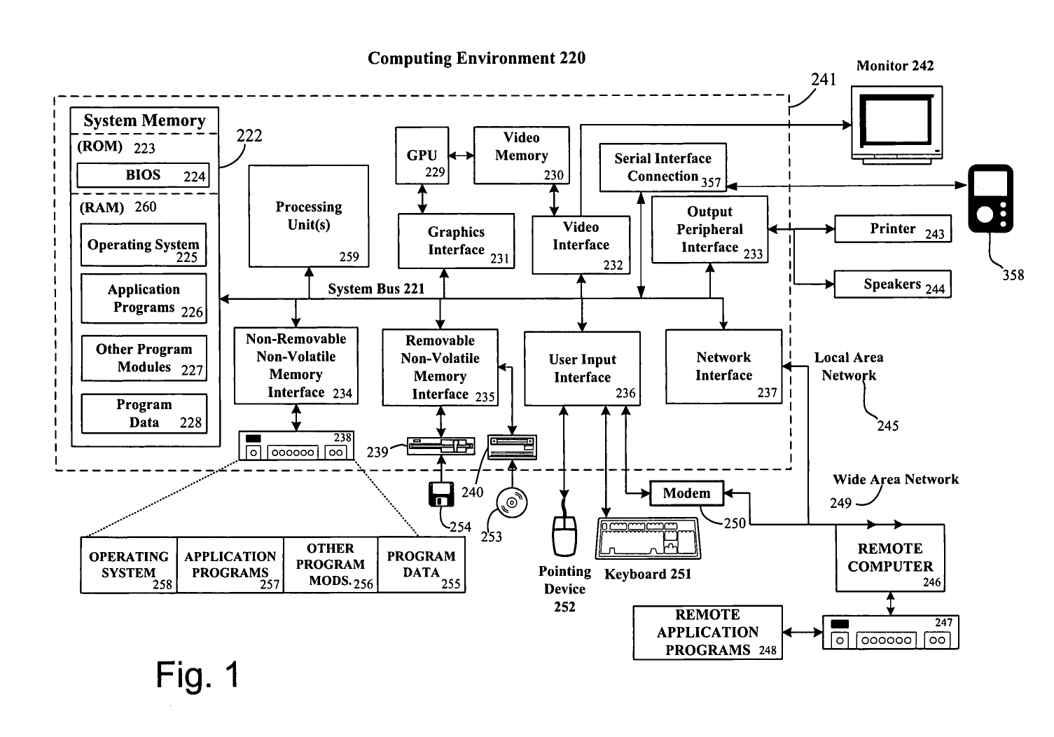

Referring to FIG. 1, shown is block diagram representing an exemplary computing device suitable for use with an attachable display system for a portable computing device or suitable as the portable computing device. For example, the computer executable instructions that carry out the processes and methods for communication with an attachable display system for a portable computing device may reside and/or be executed in such a computing environment as shown in FIG. 1. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220. For example a computer game console may also include those items such as those described below for use in conjunction with implementing the processes described above.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 1, provide storage of computer readable instructions, data structures, program modules and other data for the computer 241. In FIG. 1, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB) 357. In particular, other connections to system bus 321 include a serial interface connection 357 which provides power and data connection services to a serial interface device 358. Examples of serial connections 357 include a firewire, USB, and optical interfaces. Examples of serial interface devices 358 include flash memory devices, media devices, and other peripheral devices such as scanners and combination devices. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 1. The logical connections depicted in FIG. 1 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 1 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

In light of the diverse computing environments that may be built according to the general framework provided in FIG. 1, the systems and methods provided herein cannot be construed as limited in any way to a particular computing architecture. Instead, the invention should not be limited to any single embodiment, but rather should be construed in breadth and scope in accordance with the appended claims.

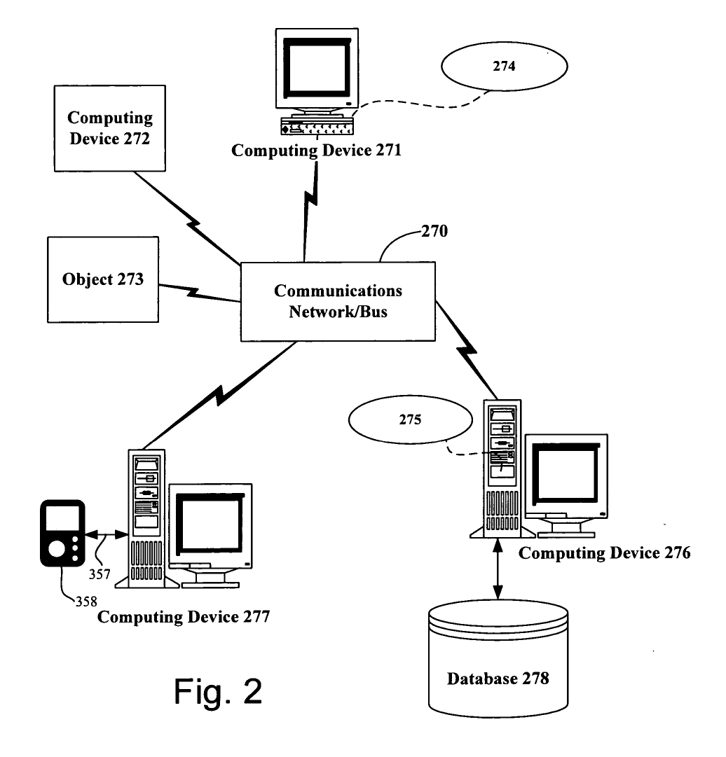

Referring next to FIG. 2, shown is an exemplary networked computing environment in which many computerized processes may be implemented to perform the processes described below. For example, an attachable display system for a portable computing device may be part of such a networked environment with various clients on the network of FIG. 2 using and/or implementing the attachable display system for a portable computing device 358. A serial interface connection 357 which provides power and data connection services to a serial interface device, such as a portable computing device 358, for example. Examples of serial connections 357 include a firewire, USB, and optical interfaces. Examples of serial interface devices 358 include flash memory devices, media devices, and other peripheral devices such as scanners and combination devices. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 2 and the further diversification that can occur in computing in a network environment such as that of FIG. 2, the systems and methods provided herein cannot be construed as limited in any way to a particular computing architecture or operating system. Instead, the invention should not be limited to any single embodiment, but rather should be construed in breadth and scope in accordance with the appended claims.

Attachable Display and Portable Device

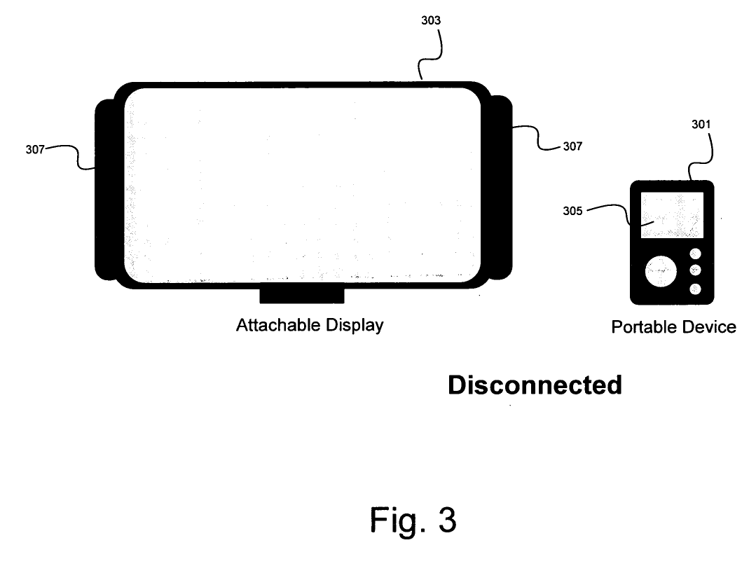

Referring next to FIG. 3, shown is a diagram illustrating a front view of an exemplary disconnected attachable display 303 and exemplary portable computing device 301. A larger display 303 than the display 305 of the portable device 301 is used that can be directly attached to the portable device 301 to enhance the experience of the portable device 301. The attachable display 303 may be purchased separately from the portable device 301, thus keeping the price lower for the portable device 301. The attachable display 303 may, for example, include digital video decoding capability to provide enhanced playback experience. The compact media player or portable device 301 may be able to store the videos, but might not have the ability to playback video, so the video decoding happens as part of the larger display, for example. Also, the attachable display may have audio output capabilities such as speakers 307 and may receive audio data through the same connection as that for video data.

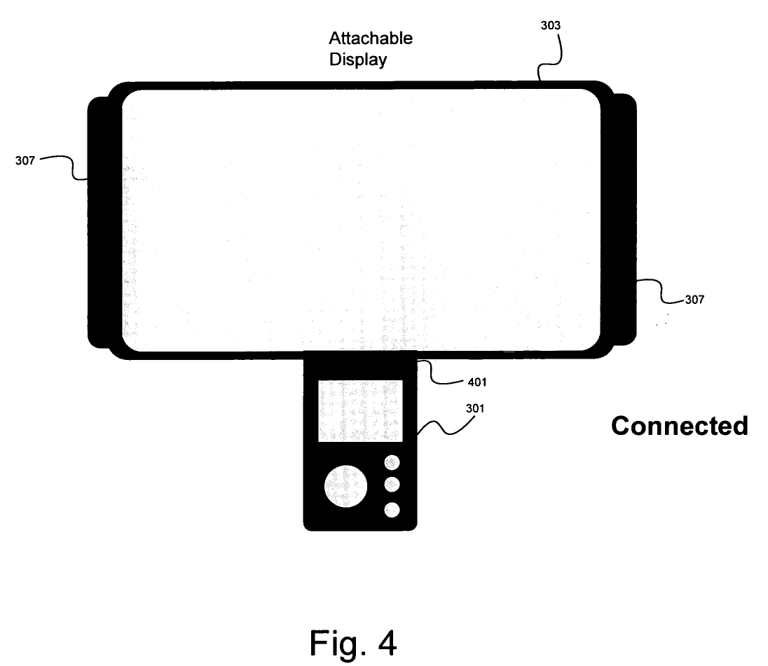

Referring next to FIG. 4, shown is a diagram illustrating a front view of an exemplary connected attachable display 303 and exemplary portable computing device 301. The attachable display 303 plugs in, for example, directly to the device 301 without cables via a male or female connector 401. The physical method of connection may be via universal serial bus (USB), Firewire®, or any serial or parallel connection. The attachable display 303 is used to view video, or pictures, play audio data, or view the user interface of the portable device 301.

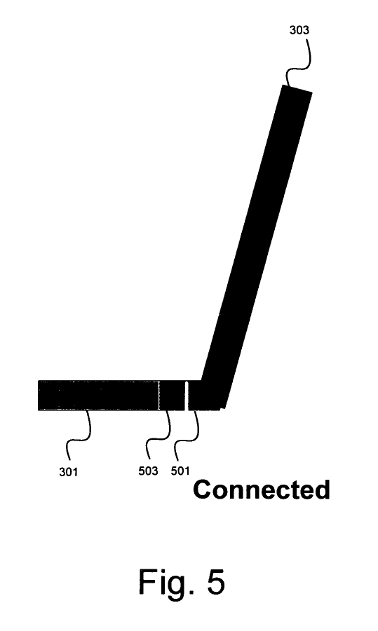

Referring next to FIG. 5, shown is a diagram illustrating a side view the exemplary connected attachable display 303 and exemplary portable computing device 301. The attachable display 303 may be, for example, in an upright or semi upright position while attached to the portable device 301 via a stand or pedestal 501. The attachable display 303 may also have, for example, a dock 503 to hold the portable device 301. Also, the portable device 301, may act as a pedestal or dock to hold the attachable display 303 as shown in FIG. 5.

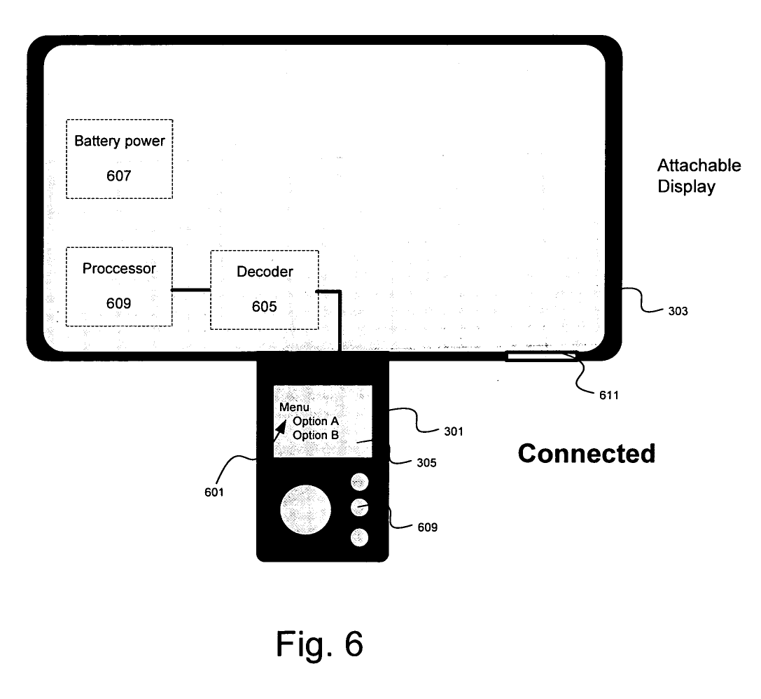

Referring next to FIG. 6, shown is a diagram illustrating a front view an exemplary connected attachable display 303 with additional options and exemplary portable computing device 301 displaying an optional menu 601. When the portable device 301 is coupled to the attachable display 303, the screen associated with the portable device 305 may assume a secondary display function 601. For example, it may simply function as a touch-screen user interface (UI) 601 or it may display textual metadata or closed-captioning associated with the display on the attachable display 303.

The display, for example, also includes a processor 609 operably connected to a video decoding capability 605 to provide digital video decoding, scaling, and a general enhanced playback experience of video data stored on the portable device 301. The display may also include additional battery capabilities 607 to extend the playback life and also to accommodate a portable device 301 whose battery size may perhaps only be optimized only for audio playback. 11. The attachable display can draw power from the portable device. The attachable display 303 can, for example, draw power from its own power supply or onboard battery/batteries 607. The attachable display 303 can feed power from its own power supply or onboard battery/batteries 607 to the portable device 301.

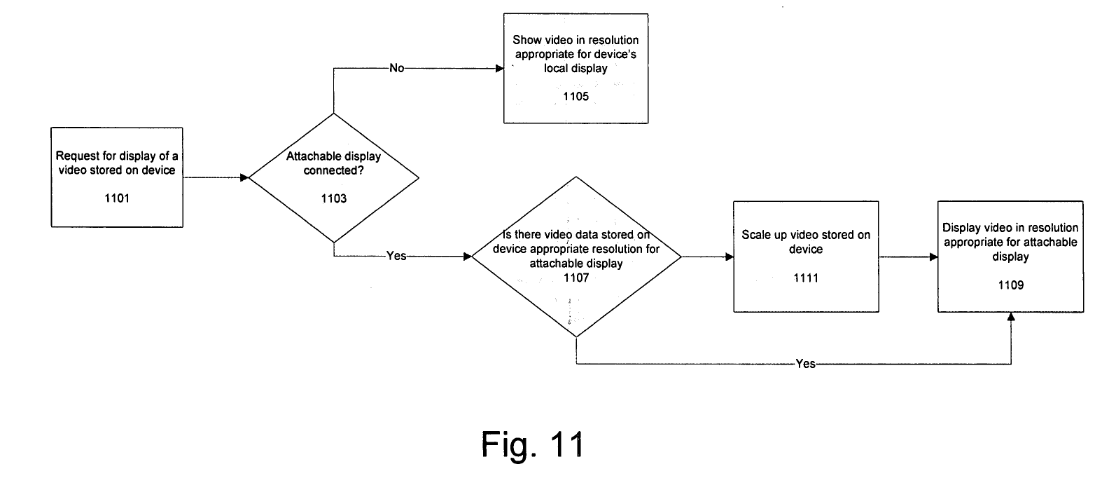

The attachable display 303, for example, has video display capabilities that can be communicated to the portable device 305 so the portable device can determine the appropriate mode of operation to provide the correct video data to the attachable display 303. This is explained in more detail below with reference to FIG. 11. Similarly, depending upon the processing workload, the processor 609 in the attachable display 303 intermittently delegates some video/audio processing to the processor in the portable device 301 to improve the performance. 6. Also, in an embodiment wherein the attachable display 303 has a processor 609, the attachable display 303, may, for example, display its own UI or query the attached device 301 for the appropriate UI to display, and then display it.

The experience on the connected attachable display 303 is controlled by controls 609 on the portable device 301, the portable device's touch screen 305, an accessory remote control (not shown), or controls 611 on the attachable display 303 itself. The logical method -of connection between the portable device 301 and attachable display 303 is, for example, Multipurpose Transaction Protocol™ for the Internet (MTP™/IP). MTP™/IP is a high speed transport protocol that is fully compatible with existing network standards, requires no changes to the network or operating systems, and is transparent to the end user. However, any transport protocol suitable for use in such an environment may be used.

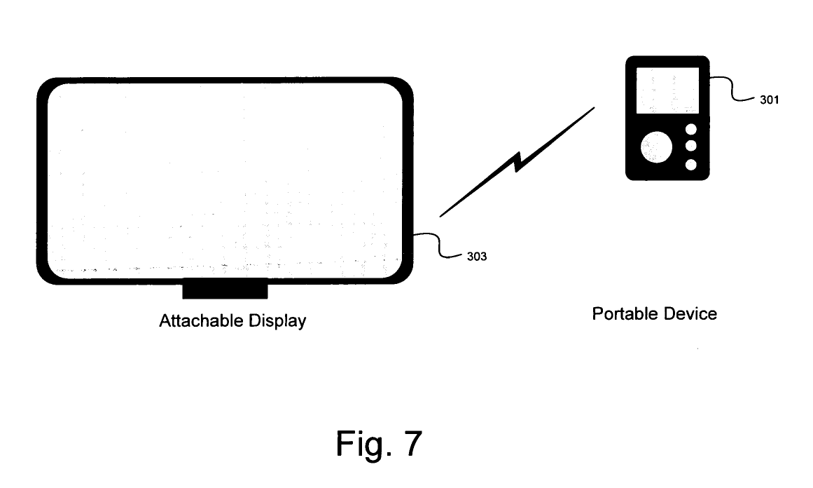

Referring next to FIG. 7, shown is a diagram illustrating a front view of an exemplary disconnected attachable display 303 and exemplary portable computing device 301 in wireless communication with each other. The communication of video and other data as described above between the portable device 301 and attachable display 303 may alternatively, or in addition to a physical connection, be made over a wireless network connection, with a wireless transmitter and receiver in both the attachable display 303 and portable device 301.

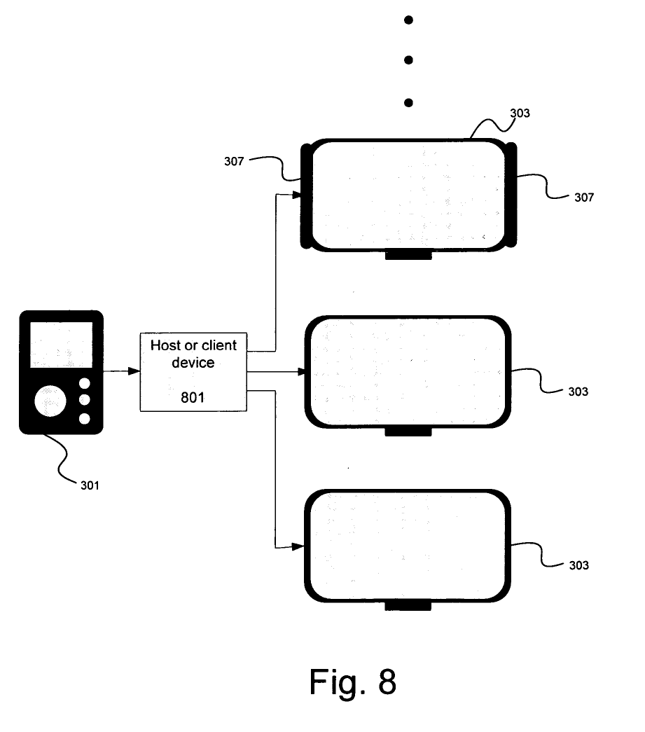

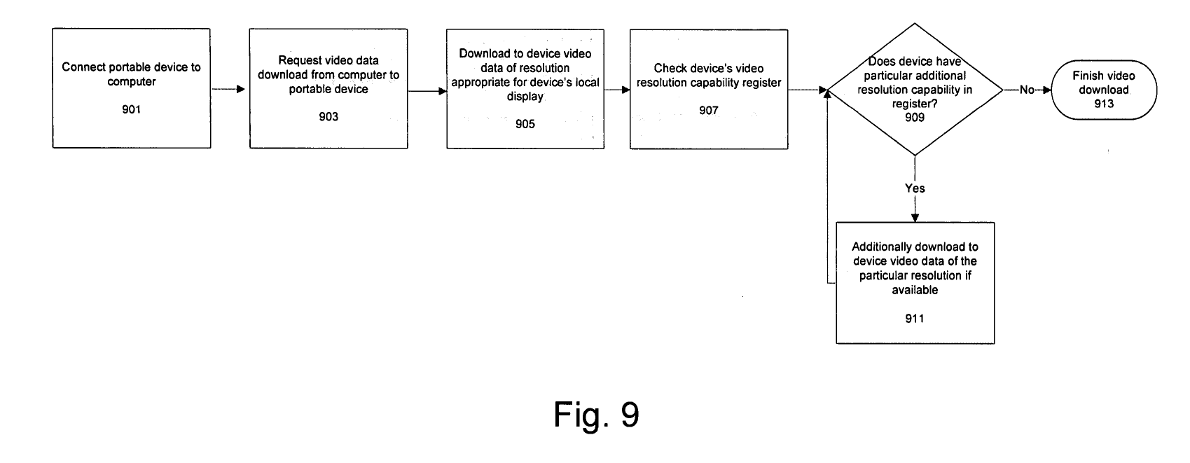

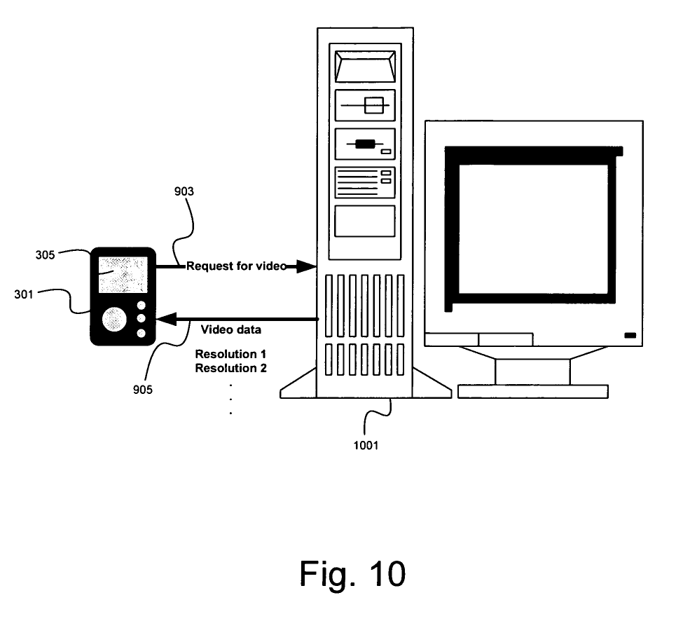

Referring next to FIG. 8, shown is a diagram illustrating a front view of a plurality of exemplary attachable displays connected to an exemplary portable computing device. Instead of an attachable display 303, the device can plug directly into a host or client device 801 that acts as the master of a display 303 or multiple displays, as shown in FIG. 8. An example scenario is connecting a compact media player (e.g., a portable device 301) to a minivan's entertainment system so all passengers can view a movie on their display(s) 303. Also, the video and audio capabilities of the automobile's entertainment system may be stored on the portable device 301, such that when the portable device downloads audio data, it will download data of a resolution or format (e.g., 5.1 channel surround) appropriate for the automobile's entertainment system. See the description below referring to FIGS. 9 and 10 for a more detailed explanation of the device 301 audio/video capabilities register.

Referring next to FIGS. 9 and 10, shown is a flow chart illustrating an exemplary process of a portable computing device 301 obtaining video and/or audio data for possible display or play on an attachable display 303 that may also have audio output capabilities such as speakers. Shown in FIG. 10 is diagram illustrating a front view of the exemplary portable computing device 301 in communication with another computing device 1001, from which the portable computing device 301 obtains video and/or audio data. First, a connection is made 901 between the portable device 301 and the computing device 1001. Then a request is made to download to the device 301, video data from the computer 1001. Video and/or audio data of a resolution appropriate for device's local display 305 is then downloaded 905 to the device 301 from the computer 1001. For example, different appropriate audio capabilities may be compressed stereo or full 5.1 or 7.1 channel audio. A check is then made 907 to the video device's 301 video/audio resolution capability register. This register has, for example, all video and/or audio resolutions and formats that are appropriate for one or more attachable displays 303 for that device 301. For example, if the portable device 301 mates to the attachable display device 303 or an entertainment system for the first time, the device's video resolution capability register is updated to show that the device 301 can handle video at a higher resolution, or should receive a higher resolution, so the next time it syncs with a computing device 1001 (e.g., a PC), the computing device 1001 will give the portable device 301 a higher resolution file or both the higher and the lower resolution files. Essentially, mating the device and display for the first time, updates the device 301 capabilities data with respect to audio and video. A determination is then made 909 whether the device has a particular additional resolution capability as noted in the device's register. If it does, then the next step is to additionally download 911 to the device 301 video data of the particular resolution, if available. If it doesn't, then the download of video data to the device 301 is completed 913.

Referring next to FIG. 11, shown is a flow chart illustrating an exemplary process for a portable computing device 301 displaying video data on an attachable display. 4. In the case of video or pictures, the optimal resolution shows on the attachable display 303. When the attachable display 303 is not connected, the local display 305 on the device 301 shows the appropriate resolution. As an example, a QVGA device with a VGA attachable display 303 would show the video at QVGA on the portable device's 301 screen 305 and when the VGA attachable display 303 is attached, video shows either as true VGA or QVGA that is scaled up to fit the screen. An example process is shown in the flow chart of FIG. 11. First, a request is made 1101 for display of video stored on the device 301. A determination is then made 1103 whether an attachable display 303 is connected to the device 301. If it is not, then the video is displayed 1105 in a resolution appropriate for device's local display 305. If the attachable display 303 is connected, then a determination is made 1107 whether there is video data stored on the device 301 appropriate resolution for attachable display 303. If there is, then the video from the device 301 of a resolution appropriate for the attachable display 303 is shown 1109 on the attachable display 303. If not, then the video stored on device 301 is scaled up 1111 and then shown 1109 on the attachable display 303. this scaling up may be performed by the processor 609 attachable display 303 itself or the device 301. A corresponding similar process to that above is also applicable to the portable device 301 playing audio data appropriate for the capabilities of the attachable display.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

Finally, the disclosed embodiments described herein may be adapted for use in other processor architectures, computer-based systems, or system virtualizations, and such embodiments are expressly anticipated by the disclosures made herein and, thus, the present invention should not be limited to specific embodiments described herein but instead construed most broadly.

What is Claimed:

1. A method for processing video data for possible display on an attachable display comprising:
downloading to a portable computing device video data of a resolution appropriate for the device's local display;
updating a video data resolution display capability of the portable device according to that which is appropriate for display on an attachable display when the attachable display is connected to the portable device for a first time; and
downloading video data of at least one resolution appropriate for display on at least one attachable display for the portable device.

2. The method of claim 1 further comprising:
checking whether the device has a capability to display video of the appropriate resolution to an attachable device before downloading the video of the appropriate resolution to the device.

3. The method of claim 2 further comprising:
determining whether an attachable display is connected to the device;
if the attachable display is not connected, then displaying the video of a resolution appropriate for device's local display;
if the attachable display is connected, then displaying video from the device of a resolution appropriate for the attachable display, if such video is stored on the device.

4. The method of claim 3 further comprising:
if the attachable display is connected to the device, but video of a resolution appropriate for the attachable display is not stored on the device, then scaling up the video stored on the device for display on the connected attachable device.

5. The method of claim 4 wherein the attachable display has a processor for decoding video from the device and audio output capability to play audio data from the device.

6. The method of claim 5 wherein the attachable display is wirelessly connected to the portable device for display of video data from the portable device.

7. A computer readable medium having instructions thereon for performing the steps of claim 1.

8. A computer readable medium having instructions thereon for performing the steps of claim 2.

9. A computer readable medium having instructions thereon for performing the steps of claim 3.

10. A computer readable medium having instructions thereon for performing the steps of claim 4.

11. A computer readable medium having instructions thereon for performing the steps of claim 5.

12. A computer readable medium having instructions thereon for performing the steps of claim 6.

13. A system for processing video data for possible display on an attachable display comprising:
means for downloading to a portable computing device video data of a resolution appropriate for the device's local display;
means for updating a video data resolution display capability of the portable device according to that which is appropriate for display on an attachable display when the attachable display is connected to the portable device for a first time; and
means for downloading video data of at least one resolution appropriate for display on at least one attachable display for the portable device.

14. The system of claim 1 further comprising:
means for checking whether the device has a capability to display video of the appropriate resolution to an attachable device before downloading the video of the appropriate resolution to the device.

15. The system of claim 2 further comprising:
means for determining whether an attachable display is connected to the device;
means for, if the attachable display is not connected, then displaying the video of a resolution appropriate for device's local display;
means for, if the attachable display is connected, then displaying video from the device of a resolution appropriate for the attachable display, if such video is stored on the device.

16. The system of claim 3 further comprising:
means for, if the attachable display is connected to the device, but video of a resolution appropriate for the attachable display is not stored on the device, then scaling up the video stored on the device for display on the connected attachable device.

17. The system of claim 4 wherein the attachable display has a processor for decoding video from the device and audio output capability to play audio data from the device.

18. The system of claim 5 wherein the attachable display is wirelessly connected to the portable device for display of video data from the portable device.

19. An automobile multimedia display system comprising:
an interface operable for connection with a portable device to play video and audio stored on the portable device on the automobile multimedia display system, a processor operable to decode video from the portable device;
a display operable to display decoded video data from the portable device;
audio output capabilities operable to play audio stored on the portable device, wherein the display and portable device may be disconnected from each other by unplugging the portable device; and
a display capabilities indication mechanism configured to indicate to the portable device display capabilities of the automobile multimedia display system when the portable device is connected to the automobile multimedia display system.

20. The system of claim 19 further comprising a portable device for connection to the automobile multimedia display system, said portable device operable for and configured to download video and audio data appropriate according to the capabilities of the automobile multimedia display system, said capabilities being stored on the portable device.
